(19) United States
(12) Patent Application Publication
(10) Pub. No.: US 2008/0093763 A1
(43) Pub. Date: Apr. 24, 2008

(54) Multi-color fiber-plastic composites and systems and methods for their fabrication

(76) Inventors: Douglas Mancosh, Warwick, RI (US); James Przybylinsky, St. Helena, CA (US); Michael Haubert, Piedmont, SC (US); Jeff Mitchell, Waxhaw, NC (US)

Correspondence Address: FISH & RICHARDSON PC, P.O. BOX 1022, MINNEAPOLIS, MN, 55440-1022, US

(21) Appl. No.: 11/544,701

(22) Filed: Oct. 6, 2006

(51) Int. Cl. B29C 47/60

(52) U.S. Cl. 264/75; 264/211; 264/211.23; 425/131.1; 425/130; 425/190

(57) ABSTRACT

This invention relates to methods and systems for forming composite extrudates including at least a base polymer, a plurality of fibers dispersed in the base polymer, and one or more colorants forming a visible, multi-color pattern, e.g., mimicking the appearance of natural wood.

### TECHNICAL FIELD

This invention relates to systems and methods for fabricating extruded composites, and more particularly to systems for fabricating multi-colored fiber-plastic composite extrusions.

### BACKGROUND

In the past 25 years a new type of material has entered the plastics products market. Commonly referred to as wood-plastic composites, WPCs, the new materials have been accepted into the building products markets in applications such as outdoor decking and railing, siding, roofing and a variety of other products. The market for the wood-plastic composite has grown and now is used in automotive products as well as the building products sector of the economy.

A wood-plastic composite is a blended product of wood, or other natural fibers, and a thermoplastic material. The products can be produced with traditional plastics processes such as extrusion or injection molding. For example, many building products are produced using extrusion processing similar to conventional plastics processing. The materials are blended before or during the extrusion processing.

The wood-plastic composites often compete with wood in the building products market. This sharing of the market requires the WPCs to look as much as possible like natural wood. The surface of the extruded wood-plastic composites are often modified with various types of downstream equipment (after the product has been extruded) in an attempt to produce a wood-like appearance. The equipment includes brushes, molders, cutters, embossers, etc., which give the surface the changed appearance.

Despite the use of mechanical methods used to change the surface appearance of extruded WPCs, the extruded products often remain monochromatic. This uniform one-color surface does not offer the same polychromatic look that natural wood offers. This is particularly true with the tropical hardwoods used in outdoor decking applications.

A notable and often desirable feature of multi-colored natural wood products is the many shades of similar colors as well as the subtleties of the color shifts. Thus, it is desirable to produce WPCs that appear to be “natural” including the multi-colored variability found in wood.

### SUMMARY

The present invention features multi-color fiber-plastic composite products that exhibit a natural wood-like appearance, and systems and methods of forming such products.

According to one aspect, the invention features methods of forming a multi-color thermoplastic composite. The methods include (a) conveying and mixing a base polymer and additives (e.g., an internal processing lubricant, a base colorant, and/or a flame retardant) through an extrusion barrel in a twin-screw extruder in a first mixing region including conditions of high shear to form a composite base material; (b) dispensing a plurality of fibers into the composite base material in a second mixing region including conditions of low shear; (c) dispensing one or more colorants in controlled amounts into the extrusion barrel in the second mixing region to form a multi-colored composite material; and forcing the composite material through an extrusion die to form an extruded product having a surface with a multi-color pattern.

In some embodiments, the first mixing region has an operating temperature range of between about 60° C. and about 210° C. and/or the second mixing region has an operating temperature range of between about 120° C. to about 185° C. The first mixing region can also include conditions of high kneading.

In some implementations, the methods can also include controlling the dispensing of the one or more colorants, including sequentially executing each of a plurality of dispensing steps. Each dispensing step includes dispensing at least one of the colorants. In some cases, a delay step follows each dispensing step. None of the colorants are dispensed during the delay steps. At least some of the dispensing steps can include dispensing two or more of the colorants. In some cases, each of the dispensing steps include dispensing no more than two colorants.

According to some embodiments, the step of dispensing one or more colorants includes dispensing each of four visibly distinct colorants according to a predetermined sequence. The sequence is executed over a duration of between about 40 and about 580 seconds, e.g., between about 170 and about 200 seconds. The sequence includes dispensing one or more of the colorants in each of a plurality of steps of between about 1 seconds and about 15 seconds each. Each dispensing step is followed by a delay step of between about 1 and about 15 seconds during which none of the four colorants are dispensed. In some cases, each dispensing step includes dispensing one or more of the colorants at a rate of between about 5 lb./hr and about 30 lb./hr. Different ones of the colorants can be dispensed in different dispensing steps. In some cases, each of the one or more colorants is disposed in a corresponding carrier resin. In such cases, the step of dispensing the one or more colorants can include dispensing between about 0.4 and about 12 ounces (e.g., between about 1.5 ounces and about 2.5 ounces) of a first carrier resin carrying a first colorant; dispensing between about 0.1 and about 6 ounces (e.g., between about 0.5 ounces and about 0.7) of a second carrier resin carrying a second colorant; dispensing between about 0.3 and about 12 ounces (e.g., between about 1.5 ounces and about 2.0) of a third carrier resin carrying a third colorant; and dispensing between about 0.5 and about 18 ounces (e.g., between about 2.0 ounces and about 3.0 ounces) of a fourth carrier resin carrying a fourth colorant. The step of conveying and mixing the base polymer and additives can include conveying the base polymer and additives at a feed rate of between about 1,000 lb./hr and about 2,000 lb./hr. In some cases, a total volume of colorant dispensed over the duration of the sequence includes between about 25% and about 31% of a first colorant; between about 8% and about 13% of a second colorant; between about 23% and about 25% of a third colorant; and between about 35% and about 40% of a fourth colorant.

In some embodiments, the methods also include heating the composite material, e.g., frictional and/or electrical heating, as it is conveyed though the extrusion barrel to form a molten composite.

According to some implementations, the twin-screw extruder includes a plurality of screw segments arranged to form twelve discrete processing zones. The first mixing region includes a first five of the twelve processing zones and the second mixing region includes a last seven of the twelve processing zones. In these cases, the method can also include heating the composite material from a temperature of about 60° C. to a temperature of about 210° C. as it is conveyed along a first four of the twelve processing zones and/or cooling the composite material from a temperature of about 210° C. to a temperature of about 150° C. as it is conveyed along a last eight of the twelve processing zones.

In some examples, the one or more colorants are dispersed in a carrier polymer, e.g., high density polyethylene, low density polyethylene, linear low density polyethylene, polypropylene, polycarbonate, thermoplastic polyurethane, an alloy of polycarbonate and thermoplastic polyurethane, polystyrene, acrylonitrile butadiene styrene (ABS), and acrylonitrile atyrene acrylate (ASA). The carrier polymer can include a material that is different from the base polymer. The carrier polymer can include the same material as the base polymer. In some cases, the carrier polymer has a melt flow index that is substantially the same as a melt flow index of the base polymer. The carrier polymer can also have a melting point that is substantially the same as a melting point of the base polymer.

In another aspect, the invention features systems for forming an extruded fiber-plastic composite product. The systems generally include a twin-screw extruder having a pair of extrusion screws arranged in parallel. Each of the extrusion screws includes a plurality of discrete screw segments connected in series and configured for mixing and conveyance of a base polymer. The systems also include an extrusion barrel that defines an inner cavity, which houses the twin-screw extruder. The extrusion barrel includes a first entry port for introduction of the base polymer. The extrusion barrel also includes a second entry port, downstream of the first entry port, for introduction of a plurality of fibers and one or more colorants; and an extrusion die, downstream of the second entry port. The twin-screw extruder is configured to convey the materials through the extrusion die to form an extruded product.

The plurality of discrete screw segments of a given one of the screws include segments having contrasting screw profiles arranged to define first and second regions. The first region is configured for relatively high shearing of the base materials, thereby to provide a thoroughly mixed composite material. The second region is downstream of the first region and configured for relatively low shearing of the composite material and colorants, thereby to inhibit thorough mixing of the one or more colorants with the composite material.

In some embodiments, the first region is also configured for relatively high kneading of the base material.

In some cases, the extrusion screws are configured for co-rotational movement.

According to some implementations the first region includes a plurality of screw segments arranged to form a plurality of discrete processing zones. The plurality of processing zones include, at least, first, second and third processing zones. The first processing zone includes one or more conveying elements. The second processing zone, disposed downstream of the first processing zone, includes one or more feed elements. The third processing zone, disposed downstream of the second processing zone, includes one or more kneading elements.

In some cases, the first region also includes a fourth processing zone, downstream of the third processing zone, having one or more conveying elements. The first processing zone can also include a fifth processing zone, downstream of the fourth processing zone, having one or more kneading elements.

In some embodiments, the second region includes a plurality of screw segments arranged to form a plurality of discrete processing zones. In these cases, the plurality of discrete processing zones include sixth and seventh processing zones. The sixth processing zone is disposed downstream of the first region and includes one or more conveying elements. The seventh processing zone is disposed downstream of the sixth processing zone and includes one or more mixing elements. The second region can also include an eighth processing zone, downstream of the seventh processing zone, having one or more conveying elements. In some cases, the second region includes a ninth processing zone, downstream of the eighth processing zone, including one or more mixing elements. The second region can also include a tenth processing zone disposed downstream of the ninth processing zone and including one or more conveying elements. In some cases, the second region also includes an eleventh processing zone disposed downstream of the tenth processing zone and including one or more mixing elements. In these cases, the second region can also include a twelfth processing zone disposed downstream of the eleventh processing zone and including one or more conveying elements.

According to some embodiments, a side-feeder is arranged in fluid communication with the second entry port and is configured for controlled dispensing of the fibers or one or more colorants into the composite material. The systems can include a programmable logic controller for controlling the dispensing of the fibers or one or more colorants. The programmable logic controller can be configured to control, e.g., an amount of colorant to be dispensed, a time period during which the colorant is dispensed, and/or a length of time between colorant dispensings. In some cases, the side-feeder includes a multiple-array feeder having a plurality of discrete feeders each containing a corresponding colorant and each operable to dispense the corresponding colorant.

In some implementations, the extrusion barrel can include an additional entry port disposed in a position downstream of the second entry port, for introducing one or more additional colorants or additives.

The screw segments can be arranged to form a screw profile that allows for controlled mixing of the one or more colorants with the base materials, thereby to provide a desired visual effect on an exposed surface of the extrudate.

In yet another aspect, the invention features composite extrudates. The composite extrudates include a base polymer (e.g., a crystalline polymer), a plurality of fibers (e.g., wood, hemp, kenaf, abaca, jute, flax, and ground rice hulls) dispersed in the base polymer, and four or more colorants, of different hues, visible on a surface of the extrudate and forming a random pattern (e.g., mimicking the appearance of natural wood). In some embodiments, the extrudates can also include one or more additives, e.g., base colorants, lubricants, and/or flame retardants.

In some implementations, the colorants are dispersed in a carrier polymer (e.g., a crystalline polymer or an amorphous polymer). For example, the carrier polymer can be selected from polyolefins, styrenes, urethanes, polycarbonates, and/or ABS resins. The carrier polymer can include the same material as the base polymer. In some cases, the carrier polymer has a melt flow index that is substantially the same as a melt flow index of the base polymer. The colorants can also be dispersed in a carrier polymer having a melting point that is substantially the same as a melting point of the base polymer.

Implementations can also include one or more of the following additional features. The extrudate can have a substantially uniform density throughout its cross-section. The extrudate can include more than 50 percent by weight of the fibers. The random pattern can include, for example, a sharp delineation in color and/or a gradual shifting of color. The base polymer can be a polyethylene mixture including virgin HDPE, recycled HDPE, and reprocessed composite material including HDPE and natural fibers. For example, in some cases, the polyethylene mixture includes between about 30 and about 40 percent by weight virgin HDPE, and between about 0 and about 15 percent by weight recycled HDPE, and between about 0 and about 10 percent by weight reprocessed composite material.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

The patent or application file contains at least one drawing executed in color. Copies of this patent or patent application publication with color drawing(s) will be provided by the Office upon request and payment of the necessary fee.

FIG. 1A is a perspective view of a fiber-plastic composite extrusion fabricated in accordance with systems and methods of the present invention.

FIG. 1B is a color photograph showing a first exemplary embodiment of the composite of FIG 1A.

FIG 1C is a color photograph showing a second exemplary embodiment of the composite of FIG 1A.

FIG. 2 is perspective view of a system for forming a fiber-plastic composite extrusion.

FIG. 3 is a cross-sectional schematic representation of the system of FIG. 2.

FIG. 4 is an end view of a co-rotating twin screw extruder from the system of FIG. 2.

FIG. 5 is a table outlining a screw profile of the extruder screws from the system of FIG. 2.

FIG. 6 is a table outlining a first embodiment of a color loading sequence for forming the fiber-plastic composite of FIG 1B.

FIG. 7 is a table outlining a second embodiment of a color loading sequence for forming the fiber-plastic composite of FIG 1C.

FIG. 8 is a perspective view of a Y-block adapter and extrusion die assembly from the system of FIG. 2.

FIG. 9 is a table outlining an operating temperature profile of the system of FIG. 2.

Like reference symbols in the various drawings indicate like elements.

### DETAILED DESCRIPTION

The new systems and methods can be used to combine one or more colorants, e.g., a dye or pigment dispersed in a polymeric resin, with a fiber-polymer composite mixture to form a multi-color fiber-plastic composite product.

### Multi-Color Fiber-Plastic Composite

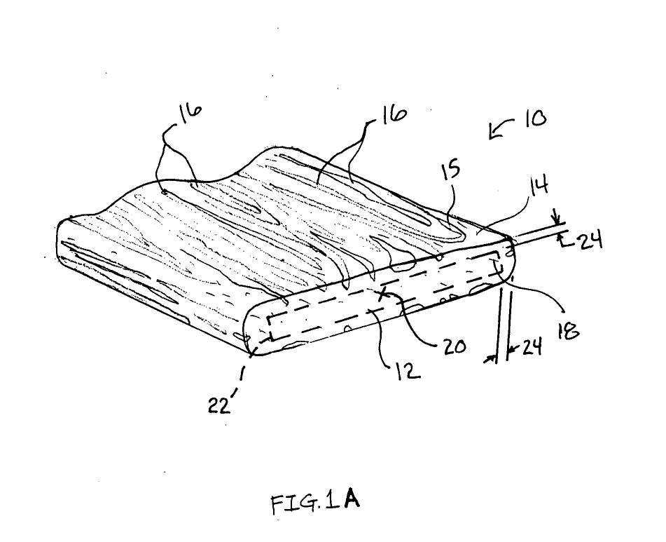

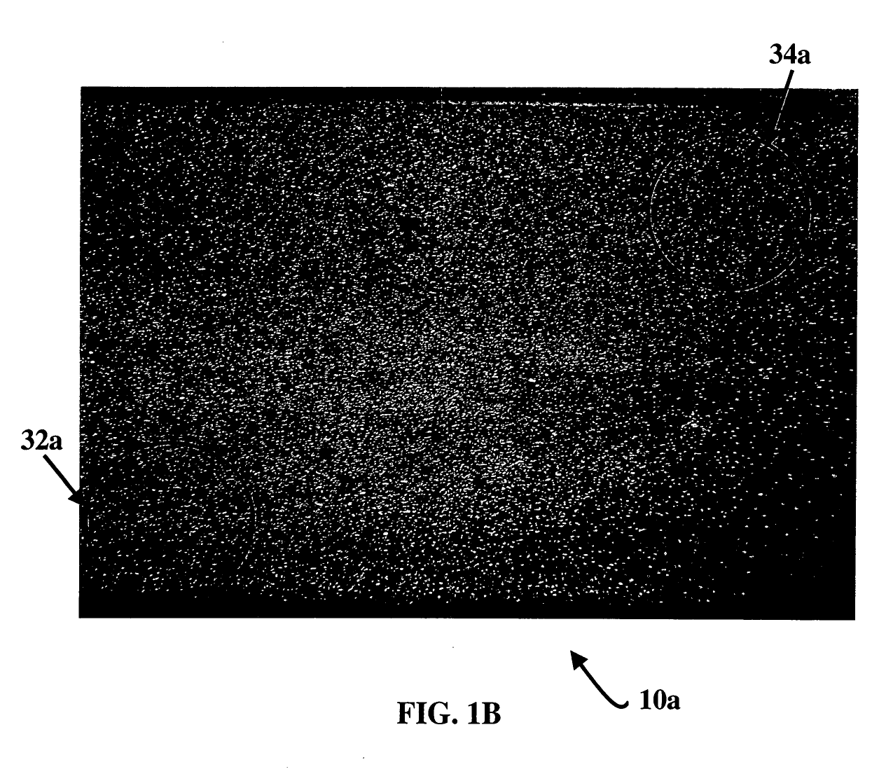

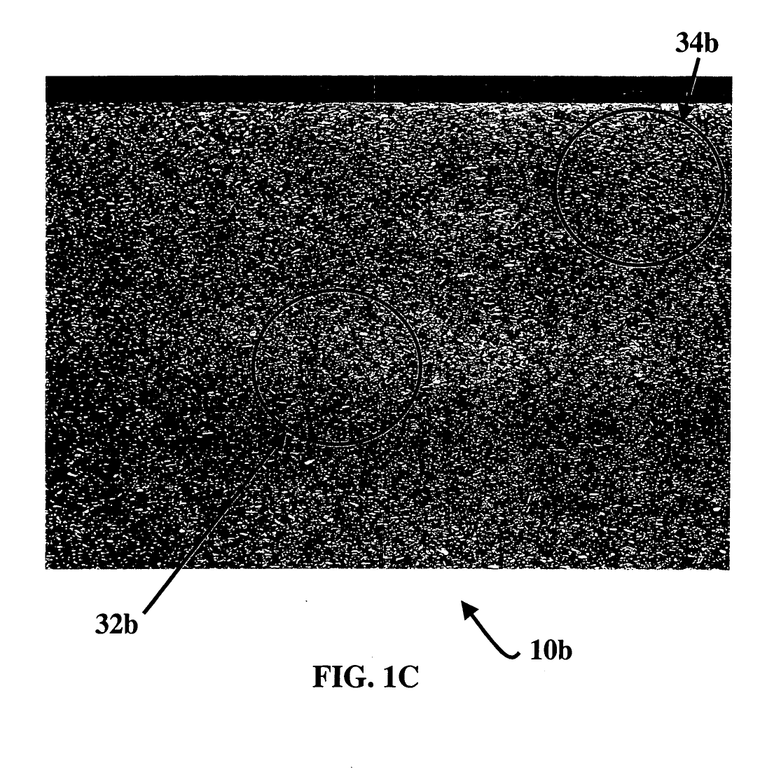

FIG. 1A shows an extruded fiber-plastic composite (i.e., extruded composite 10) formed in accordance with the present disclosure. The extruded composite 10 generally comprises a composite body 12 formed from a mixture including one or more base polymers and natural fibers 18. The natural fibers help to provide the extruded composite with the appearance and feel of a natural wood product. Generally, the natural fibers account for about 50% of the total weight of the composite 10.

The composite 10 can also include one or more colorants 15 (e.g., two, three, four, or more), which can be selectively dispersed and visible on one or more exposed surfaces 14 of the composite in a random pattern 16 to form different visible effects that mimic the appearance of natural wood, as shown in the photographs of FIGS. 1B and 1C. For example, FIG. 1B shows a first example of a fiber-plastic composite product 10a having regions that exhibit sharp delineations in color (indicated generally by 32a) interspersed with regions that exhibit a gradual shifting in color (indicated at 34a), which together form a random pattern that mimics the appearance of natural mahogany. Similarly, FIG. 1C shows a second example of a fiber-plastic composite 10b that also includes regions 32b that exhibit sharp delineations in color interspersed with regions 34b exhibiting gradual shifting in color, together forming a random pattern that mimics the appearance of natural Jatoba.

Referring again to FIG. 1A, due at least in part to processing controls, described in greater detail in the following paragraphs, the colorants 15 are disposed about the periphery of the body 12 and are maintained substantially on the exposed surfaces 14, extending a depth 24 of between about ⅛ inch and about ¼ inch towards a core 20 of the body 12 such that the core 20 is substantially free of the colorants 15.

### System Overview

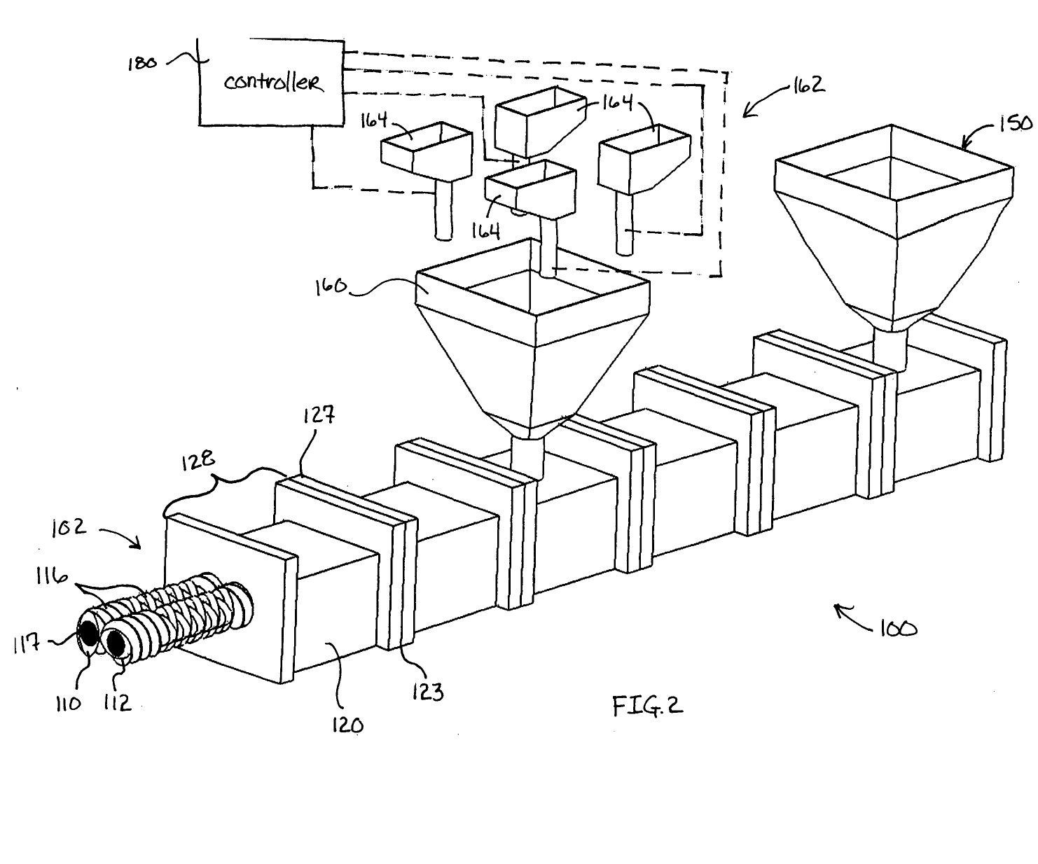

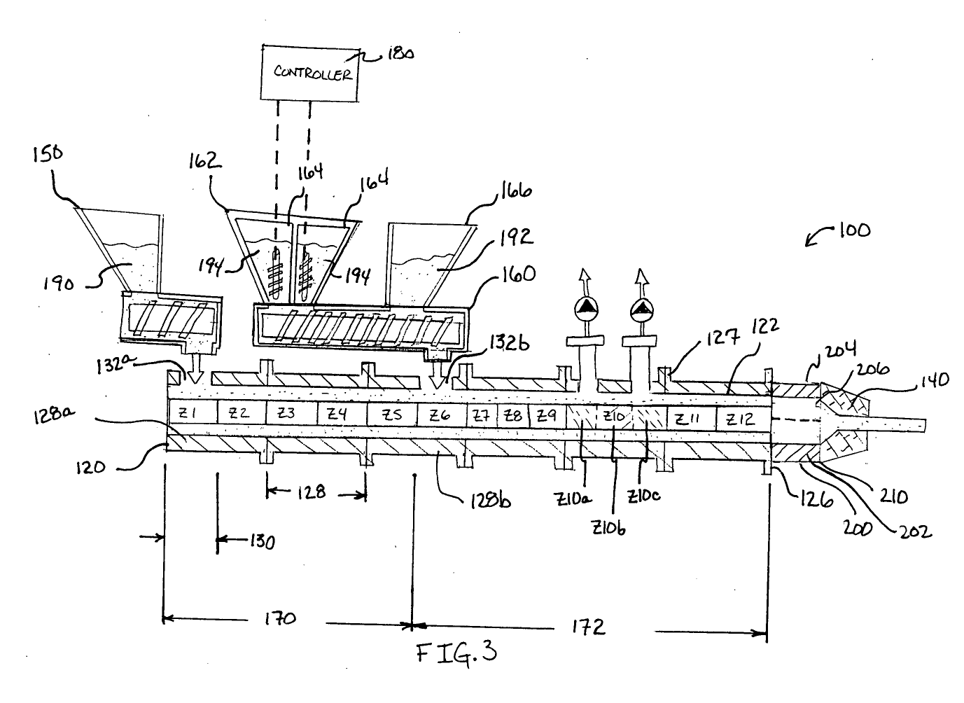

In certain embodiments the invention includes new systems for forming plastic extrusions. As shown in FIGS. 2 and 3, the new systems 100 include at least four main stations including a supply station (e.g., primary feeder) 150 that dispenses a base polymer (e.g., in the form of powders and/or pellets); a co-rotating twin screw extruder 102 arranged to receive the base polymer; a secondary feeder 160 that dispenses additional materials (e.g., additives, such as colorants) into the extruder 102 for mixing with the base polymer; and an extrusion die 140 for forming a composite extrusion with a pre-determined profile.

As best shown in FIG. 2, the extruder 102 includes at least the following components: (i) an extrusion barrel 120; and (ii) a pair of co-rotating extrusion screws 110, 112. The extrusion barrel 120 defines an internal cavity 122 where materials (e.g., base polymer and additives) are mixed and conveyed. The extrusion barrel 120 is formed as an assembly including a plurality of discrete barrel segments 128. The barrel segments 128 are arranged in series and together form the internal cavity 122, which acts as a flow path between the supply station 150 and the extrusion die 140 (i.e., for conveyance of materials such as the base polymer and additives). The extrusion screws 110, 112 each comprise a plurality of discrete screw segments 116 sealed within the internal cavity 122 and extending from a feed zone 130 to the extrusion die 140. The screw segments 116 are removable, replaceable, and interchangeable and can be arranged to achieve a desired feeding, conveying, kneading, and mixing sequence (referring to operations performed on the materials as they are conveyed through the extruder; i.e., along the internal cavity 122 of the extrusion barrel 120). The extrusion screws 110, 112 are arranged in parallel and configured for co-rotational movement relative to each other. The co-rotation movement of the extrusion screws 110, 112 mixes materials, such as the base polymer and additives, and conveys these materials through the extrusion barrel 120. Each of these components (i.e., extrusion barrel and extrusion screws) can be made of commercially available parts.

### A System for Forming Fiber-Plastic Composite Extrusions

As shown in FIGS. 2 and 3, the new systems 100 include at least four main stations including a supply station 150; a co-rotating twin screw extruder 102; a secondary feeder 160; and an extrusion die 140. The supply station 150 can include a single and/or double screw (i.e., twin-screw) loss-in-weight gravimetric feeder for throughput of solid materials, i.e., typically in the form of fibers, powders, and/or pellets, into a feed zone 130 in the extruder 102. In one exemplary embodiment, the supply station is a loss-in-weight feeder having a maximum feed rate of about 2,000 lb./hr.

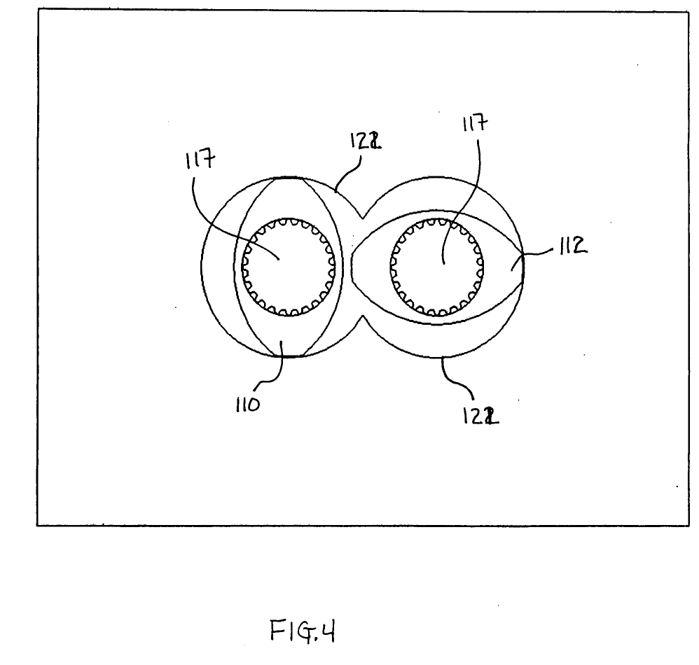

Referring still to FIGS. 2 and 3, the twin screw extruder 102 includes (i) an extrusion barrel 120; and (ii) a pair of co-rotation extrusion screws 110, 112. The extrusion barrel 120 comprises an assembly of discrete barrel segments 128 forming a substantially continuous series connection. This arrangement offers flexibility in that the individual barrel segments 128 can be moved, removed, and/or exchanged to provide different barrel configurations, e.g., to allow for different feeding (e.g., entry ports), vacuum, or injection locations. In addition, the segmented barrel configuration offers the flexibility of choosing between multiple entry ports into the extruder 102. For example, the use of more than one entry port can be employed to achieve a more sophisticated extruded product in terms of both product properties and appearance. Each barrel segment 128 defines a barrel bore 121 (shown, for example, as figure-8 shape in FIG. 4), which, when assembled, form a substantially continuous internal cavity 122 along the length of the extrusion barrel 120 (i.e., extending from the feed zone 130 toward the extrusion die 140). Each barrel segment 128 includes electrical heating elements (e.g., heating cartridges (not shown)) and cooling bores (not shown) for counter-flow liquid cooling, together providing for optimize-able dynamic regulation and temperature control.

Individual barrel segments 128 are selected from open barrels (i.e., with entry ports for feed zones), open barrels with inserts (for degassing, metering, or injection zones), closed barrels, and/or combined barrels for combined feeding (e.g., side feeding of additives) and venting, each being between about 4 inches and about 20 inches in length. As shown in FIG. 3, the extrusion barrel 120 includes at least two open barrel segments 128a, 128b, i.e., for fluid communication with the primary and secondary feeders 150, 160. Preferably, a substantially leak-proof interface (i.e., up to 30 bar internal pressure) is formed at the interface between adjacent ones of the barrel segments 128. Adjacent barrel segments 128 can be connected, e.g., with bolted flanges 127, as shown in FIG. 2, or, alternatively, C-clamp barrel connectors (not shown) can be employed.

Referring to FIG. 2, the co-rotating extrusion screws 110, 112 provide for a relatively efficient type of extruder in terms of its ability to disperse and distribute materials within a matrix of extruded materials. As shown, for example, in FIG. 2, each of the extrusion screws 110, 112 comprises a segmented screw arrangement, wherein each of the extrusion screws 110, 112 include a series of discrete elements (i.e., screw segments 116) fit onto a shaft 117. The individual screw segments 116 are each removable and replaceable and may be selected to have contrasting screw profiles, thus, allowing for a flexible screw profile arrangement that can be tailored to specific applications and/or process requirements.

Among the various types of screw segment profiles, the individual segments can be selected from conveying elements, mixing elements, kneading elements, and/or special elements. Mixing and kneading elements are designed in a variety of lengths, pitches and pitch directions. Kneading blocks are constructed using several disks of equal or varying widths spaced at equal distances from each other. The order in which kneading, mixing, conveying, and other segments are arranged must be specified as described herein to control shear, melt, and energy control. In addition, this mixing process provides homogeneous melt and controlled dispersion-distribution of additives. The segmented screws 110, 112 allow for modification of the screw profile, e.g., for modification of processing parameters, varying physical properties, and/or surface appearance of the extruded product. Generally, an overall diameter of the screw segments remains constant; however, the shape of flights (e.g., pitch and distance between flights) can vary.

The screw segments 116 should be arranged so that about a first half of the extruder 102 provides relatively high shearing and kneading (i.e., for dispersive mixing of the base materials) and about the second half provides relatively low shearing (i.e., for distributive mixing of the composite material and colorants), thereby to inhibit thorough mixing of the one or more colorants with the composite material.

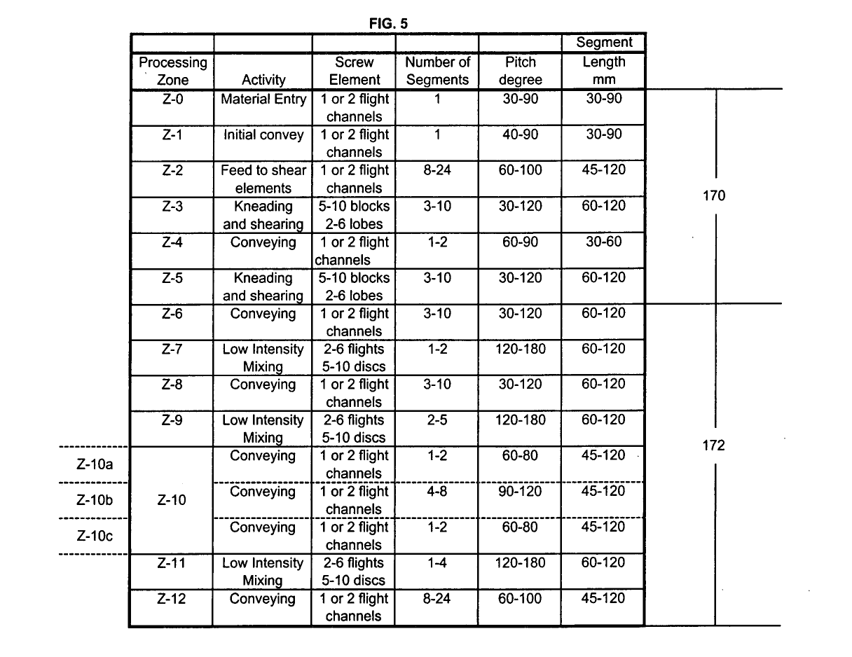

In one exemplary embodiment, each of extrusion screws 110, 112 comprises between about forty-one (41) and about one hundred-fifteen (115) discrete screw segments 116, each between about 60 mm and about 120 mm in length. This particular configuration defines twelve (12) processing zones Z1-Z12, each zone comprising a change in screw profile defined by one or more discrete screw segments (see, e.g., FIG. 5). In this embodiment, the screw segments 116 are arranged such that the first five zones form a first mixing region 170 configured for dispersive mixing (i.e., relatively high kneading and shearing), and the last seven zones form a second mixing region 172 configured for distributive mixing (i.e., relatively low shearing). In dispersive mixing cohesive resistances between particles have to be overcome to achieve finer levels of dispersion; dispersive mixing is also called intensive mixing. In other words, dispersive mixing includes the mixing and breaking down of discrete particles to form a compound. Distributive mixing aims to improve the spatial distribution of the components without cohesive resistance playing a role; it is also called simple or extensive mixing. Distributive mixing allows for division and spreading of discrete particles into a mixture without substantially effecting the size and/or shape of the particles (i.e., no breaking down of the particles).

FIG. 5 outlines the various screw segments employed in this embodiment. In general, conveying and feed elements (e.g., Z1, Z2, Z4, Z6, Z8, Z10, and Z12) serve to displace material through the extrusion barrel 120, from the first entry port 132a towards the extrusion die 140. Kneading blocks (see, e.g., Z3 and Z6) provide for high shear and dispersing (e.g., of base materials). Mixing elements (see, e.g., Z7, Z9, and Z11) provide for relatively high particle distribution (e.g., high distribution of fiber materials). Zones having a flight pitch less than 90° provide for compression of materials. Zones having a flight pitch of about 90° provide for frictional heating of the materials while providing little if any aid in the conveyance of the material. Zones having a flight pitch exceeding 90° provide for relatively high conveyance.

Referring to FIGS. 3 and 5, zones Z1 and Z2 are configured for moving materials from the throat of the extruder 102 and heating it before it is introduced to zone Z3. More specifically, the first processing zone Z1 is configured to move cold material, e.g., a mixture of pelletized base materials, from an entry point, i.e., main entry port 132a, toward the second processing zone Z2. The second processing zone is configured to increase pressure on the material as it is moved forward in the direction of the third processing zone Z3. As shown in FIG. 5, the first eight to twenty-four segments making up the second processing zone Z2 have a flight pitch of between about 60° and about 100°. In this portion, conveyance is achieved primarily through the introduction of additional material from the first processing zone Z1, which results in the build up of pressure in the second processing zone Z2, which, in turn, forces the material through the second processing zone Z2.

Processing zones Z3-Z5 define a high shear section. In this section the base materials are thoroughly dispersed in a molten composite mixture. Zone Z6 marks a transition to the distributive mixing region 172, this is the zone in which the colorants and fibers are added. This zone provides for increased conveyance along or about zone Z6, i.e., moves materials along quickly thereby inhibiting cooling-off of the materials. Zones Z7-Z9 are configured to provide high distribution mixing of the fiber material with the molten composite mixture. As shown in FIG. 5, the tenth processing zone Z10 includes between about six and about twelve discrete screw segments together defining a first section Z10a of relatively high compression; followed by a section Z10b of relatively low conveyance, which allows the material to expand allowing moisture to rise to the outer surface where it can evaporate; and a second section Z10c of relatively high compression.

The eleventh processing zone Z11 is a mixing zone with a relatively high flight pitch, which provides for increased conveyance and subtle mixing. The twelfth processing zone Z12 transitions from a first section of relatively high conveyance (i.e., moves material at a relatively high flow/feed rate to inhibit cooling prior to entering the die) to a second section of relatively high compression, which provides for a build-up of pressure near the distal end of the extruder, for forcing the material through the extrusion die 130.

Referring again to FIGS. 2 and 3, one or more secondary feeders 160 are provided for dispensing one or more additional materials (e.g., natural fibers, colorants, and/or other additives) into the extrusion barrel, i.e., for mixing with the base polymer. The secondary feeders 160 move the materials into the extruder 120 through a second entry port 132b using, e.g., a single-screw or double-screw configuration. As shown in FIG. 3, the secondary feeder 160 can include a loss-in-weight gravimetric feeder 166 for dispensing fibers; and a multiple feeder array 162, e.g., volumetric auger feeders, for dispensing multiple colorants (or other additives) into the extruder. Thus, two, three, four or more colorants may be added; the number of feeders being determined by the number of colorants to be added to the extrusion process.

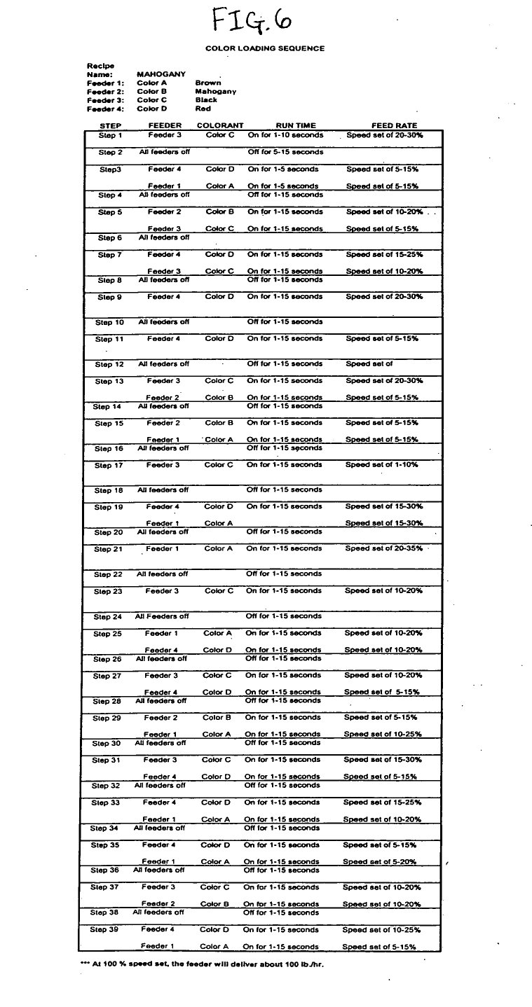

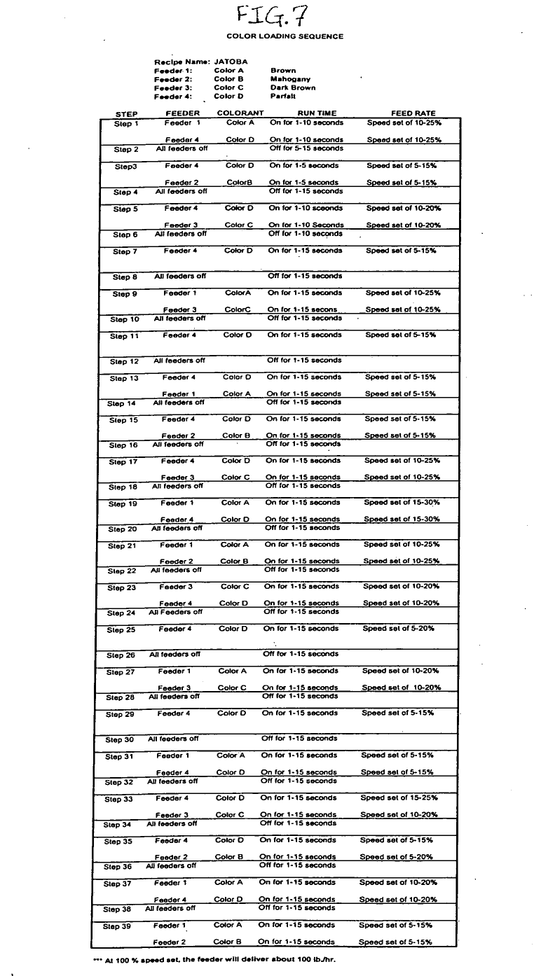

The feeders 164 are controlled through a programmable logic controller, or PLC 180. This allows for varying amounts of colorants to be added individually or in conjunction with another colorant or colorants and/or other additives. Further, the time during which colorants are being added and the time between additions can be varied using the PLC program, see, e.g., FIGS. 6 and 7. FIG. 6 illustrates one embodiment of a colorant loading sequence that implements a multiple feeder array including four discrete colorant feeders (i.e., Feeders 1, 2, 3, and 4) configured to dispense four separate colorants (i.e., Colors A (Brown), B (Mahogany), C (Black), and D (Red)), each from a corresponding one of the feeders, to create an extruded product with an appearance of natural mahogany. As shown in FIG. 6, the colorants are dispensed according to a predetermined sequence, e.g., steps 1-39. The sequence is executed over a duration of between about 43 and about 575 seconds, e.g., about 178 seconds, and can be subsequently repeated for continuous production runs.

The dispensing sequence includes a plurality of incremental dispensing steps (i.e., dispensing periods), e.g., steps 1, 3, 5, etc., of between about 1 and about 15 seconds each (e.g., between about 1 and about 10 seconds), during which one or more of the colorants is dispensed into the extrusion barrel. Each incremental dispensing step is separated by a delay step (i.e., delay period), e.g., steps 2, 4, 6, etc., of between about 1 to about 15 seconds each, during which none the colorants are dispensed. For example, as shown in FIG. 6, step 1 includes driving Feeder 3 (i.e., dispensing colorant C, e.g., black) at a rate of between about 20% to about 30% of the maximum feed rate for a duration of between about 1 to about 10 seconds, followed by a 5 to 15 second pause (i.e., step 2) before moving on to step 3. The maximum feed rate can vary for different ones of the colorants and will be dependent on the bulk density of the particular colorant. The remaining steps (e.g., steps 3 through 39) are executed in a similar manner. At each dispensing step, up to two of the feeders 164 can be driven simultaneously (see, e.g., steps 3, 5, 7, 13, etc.).

FIG. 7 illustrates another exemplary embodiment of the colorant loading sequence of the invention. FIG. 7 shows a colorant loading sequence that is configured to dispense four separate colorants (i.e., Colors A (Brown), B (Mahogany), C (Dark Brown), and D (Parfait)), via four discrete colorant feeders (i.e., Feeders 1, 2, 3, and 4), thereby to create an extruded product with an appearance of natural jatoba (i.e., hymenaea courbaril). The colorants are dispensed according to a predetermined sequence, in a similar manner as described above with respect to FIG. 6.

The dispensing sequence of FIG. 7 also includes a plurality of incremental dispensing steps/periods, e.g., steps 1, 3, 5, etc., of between about 1 and about 15 seconds each, during which one or more of the colorants is dispensed into the extrusion barrel. Again, each incremental dispensing step is separated by a delay step/period, e.g., steps 2, 4, 6, etc., of between about 1 to about 15 seconds each in duration. At each dispensing step, up to two of the feeders 164 can be driven simultaneously. For example, as shown in FIG. 7, step 1 includes driving both Feeder 1 (i.e., dispensing colorant A, e.g., brown) and Feeder 4 (i.e., dispensing colorant D, e.g., parfait) substantially simultaneously and each at a rate of between about 10 lb./hr and about 25 lb./hr (i.e., between about 10% and about 25% of a maximum feed rate of about 100 lb./hr) for a duration of between about 1 and about 10 seconds, followed by a 5 to 15 second pause (i.e., step 2) before moving on to step 3. The remaining steps (e.g., steps 3 through 39) are executed in a similar manner. The sequence is executed over a duration of between about 43 and about 575 seconds, e.g., about 197 seconds, and can be subsequently repeated for continuous production runs.

The secondary feeder can be disposed in a position downstream of the first mixing region 170, such that the colorant(s) and wood fibers are dispensed into the extruder 102 for mixing with the base polymer in the second (relatively low shear) mixing region 172. Thus, the downstream shearing effect of the extrusion screws 110, 112 on the colorants is less than the upstream effect on the base materials, thereby providing a thoroughly mixed composite material (i.e., including the base polymer and wood fibers), while at the same time allowing the colorants to blend with composite material without substantially mixing with the composite material, such that the colorants remain substantially disposed on or near an outer surface of the composite material. This aids in inhibiting the colorants from completely mixing with each other and/or with the composite material (i.e., this inhibits the formation of a homogeneous, single-color extruded product), but, rather, provides for a product with a multi-color exposed surface. As a result, this also allows the use of colorants dispersed in a carrier resin that is the same or similar to the base polymer, while still providing a multi-colored surface appearance. The use of the same or similar polymers can also provide for improved processing conditions in the system.

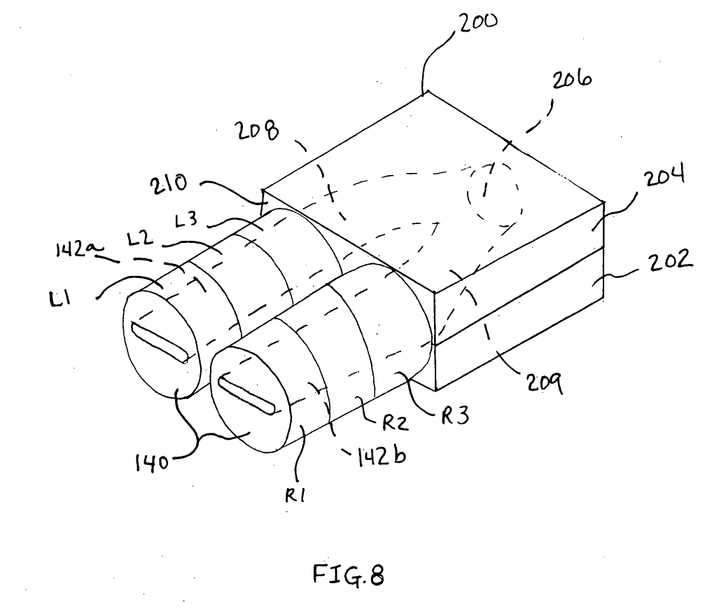

As shown in FIG. 8, the system includes a Y-block adapter 200 disposed at a distal end 126 of the extruder 102. The Y-Block adapter includes two adapter segments 202, 204 divided into three temperature zones T1-T3. Heating is performed by heating cartridges or heating bands (not shown). The Y-block adapter defines a flow channel 206, which divides flow from the internal cavity 122 of the extrusion barrel 120 into two discrete flow paths 208, 209.

The system 100 also includes an extrusion die 140 disposed at a distal end 210 of the adapter 200. The extrusion die 140 defines a pair of extrusion channels 142a, 142b, each corresponding to an associated one of the flow paths 208, 209, for forming, in tandem, a pair of extruded products (i.e., extrudates) each having a pre-determined shape (i.e., corresponding to a shape of the extrusion ports 142a, 142b). Each of the extrusion channels 142a, 142b comprises three discrete segments L1-L3, corresponding to 142a, and R1-R3, corresponding to 142b.

### Methods of Operation

In general, the new systems operate as follows.

A base mixture 190 including a base polymer (e.g., a polyethylene mixture including, for example, virgin high density polyethylene (HDPE), recycled HDPE, and/or reprocessed composite material including HDPE and natural fibers) and other additives (e.g., base colorant(s), internal processing lubricants, flame retardants, etc.), generally in the form of solid particles, e.g., powders and/or pellets, are dispensed from the supply station 150 into the feed zone 130 of the extruder 102 at a feed rate of between about 1,000 lb./hr to about 2,000 lb./hr. Other suitable base polymers include ABS, polycarbonate, polyurethane, polypropylene, high density polyethylene, low density polyethylene, linear low density polyethylene, and polystyrene. The base mixture 190 is heated, e.g., by electrical heating elements, e.g., heating cartridges (not shown), and dispersed (i.e., by mixing and breaking down of polymer particles and additive particles) as it is conveyed through the extrusion barrel 120 from the feed zone 130 towards the extrusion die 140 with the extrusion screws 110, 112 at a feed rates of between about 2,000 lb./hr and about 3,000 lb./hr.

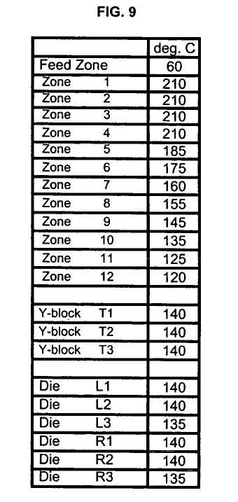

As mentioned above, the extrusion screws 110, 112 define twelve discrete processing zones Z1-Z12, wherein the first six processing zones Z1-Z6 form a first mixing region 170 (for relatively high kneading and shearing) and the last six zones Z7-Z12 form a second mixing region 172 configured for relatively low shearing. As shown in FIG. 9, the base mixture 190 is heated from a temperature of about 60° C. to about 230° C. as it is conveyed along the first four (i.e., Z1-Z4) of these processing zones, and gradually cooled to a temperature of about 175° C. before exiting the first mixing region 170, thereby forming a thoroughly mixed molten plastic material.

Still other materials, such as colorants are added to get the desired appearance effects. Colorants can be added to the extrusion process in several ways. The colorant in the form of a pigment or dye can be added directly into the extrusion barrel where it is then mixed into the base polymer, or, alternatively, the pigment or dye can be pre-compounded into a carrier resin and then added to the extrusion process. These pre-compounded colorants generally allow for better dispersion of pigment or dye into the carrier resin and then a better mixing in the extruder producing the extruded product. Suitable carrier resins include, for example, ABS, polycarbonate, polyurethane, polypropylene, high density polyethylene, low density polyethylene, linear low density polyethylene, and polystyrene. Other polymers as carrier resins will also work due, at least in part, to the ability to arrange and modify the segmented screw to adapt to the properties of the added carrier resin for the colorant.

Referring again to FIG. 3, a plurality of natural fibers 192, such as, for example, wood fibers, hemp, kenaf, abaca, jute, flax, and ground rice hulls, and one or more colorants 194 are metered into the extruder 102 through the one or more secondary feeders 160 for mixing with the composite material. The natural fibers 192 and colorants 194 are introduced into the extruder 102 in an area proximate the sixth processing zone Z6. The fibers 192 and colorants 194 are then mixed with the molten material 190 as it is conveyed through the second (relatively low shearing) mixing region 172. As the molten material is conveyed along or about the tenth processing zone Z10 it is first compressed under vacuum of about 29 in-Hg; then the material is allowed to expand, allowing moisture to rise to an outer surface for evaporation; the material is then compressed again under vacuum of about 29 in-Hg. This transition region Z10 removes moisture as the material is conveyed toward the extrusion die. The screw segments 116 are selected, as shown in FIG. 5 and as described in greater detail above, to provide high distribution of the fibers 192 in the composite material 190, while at the same time inhibiting thorough mixing of the colorants 194 with the molten material. The natural fibers 192 are metered into the extruder 102 at a rate of about 1,000 lb./hr to about 2,000 lb./hr.

In the embodiment represented in FIG. 6, four different colorants (e.g., Brown, Mahogany, Black, and Red) are each added to the composite material 190 from one of four corresponding feeders (i.e., one designated to each of the four colorants). The feeders are controlled through a programmable logic controller 180. The amounts of each colorant added, the time over which each colorant is added, and the time between sequential distributions of each colorant are controlled according to the PLC program outlined in FIG. 6. The changes in number of colorants used, the time of addition of each colorant, and the time spacing between additions gives the extruded product a surface appearance of subtle changes in color and hue as well a random appearance, and thus achieves the “natural” multi-color appearance desired for the extruded product 10.

The composite material is gradually cooled from a temperature of about 175° C. (i.e., temperature exiting the first mixing region) to a temperature of about 155° C. as it is conveyed along the second mixing region 172 towards the extrusion die 140. This cooling allows the fibers 192 to mix with composite material 190 without being destroyed by the process temperatures and aids in inhibiting the mixing of the colorants 194 with each other and with the composite material 190. The material is compressed as it is conveyed from zone Z11 to zone Z12, thus allowing pressure to build-up, e.g., between about 10 bar to about 30 bar at the extruder exit, in order to force the material through the die. The composite material is then fed into the Y-block adaptor where it increases in temperature to about 170° C. and split into two separate flows, which are forced through corresponding extrusion ports 142a, 142b of the extrusion die 140 to form a pair extruded composite parts.

### Other Embodiments

A number of embodiments of the invention have been described. Nevertheless, it will be understood that various modifications may be made without departing from the spirit and scope of the invention. Accordingly, other embodiments are within the scope of the following claims.

What is claimed is:

1. A method of forming a multi-color thermoplastic composite, the method comprising:
(a) conveying and mixing a base polymer and additives through an extrusion barrel in a twin-screw extruder in a first mixing region comprising conditions of high shear to form a composite base material;
(b) dispensing a plurality of fibers into the composite base material in a second mixing region comprising conditions of low shear.
(c) dispensing one or more colorants in controlled amounts into the extrusion barrel in the second mixing region to form a multi-colored composite material; and
(d) forcing the composite material through an extrusion die to form an extruded product having a surface with a multi-color pattern.

2. The method according to claim 1, wherein the first mixing region has an operating temperature range of between about 60° C. and about 210° C.

3. The method according to claim 1, wherein the second mixing region has an operating temperature range of between about 120° C. to about 185° C.

4. The method according to claim 1, wherein the first mixing region further comprises conditions of high kneading.

5. The method according to claim 1, wherein controlling the dispensing of the one or more colorants comprises:
sequentially executing each of a plurality of dispensing steps, wherein each step includes dispensing at least one of the colorants.

6. The method according to claim 5, further comprising executing a delay step following each dispensing step, wherein none of the colorants are dispensed during the delay step.

7. The method according to claim 5, wherein at least some of the dispensing steps include dispensing two or more of the colorants.

8. The method according to claim 5, wherein each of the dispensing steps includes dispensing no more than two colorants.

9. The method according to claim 1, wherein the step of dispensing one or more colorants comprises:
dispensing each of four visibly distinct colorants according to a predetermined sequence executed over a duration of between about 40 and about 580 seconds, said sequence including
dispensing one or more of the colorants in each of a plurality of steps of between about 1 seconds and about 15 seconds each, wherein each dispensing step is followed by a delay step of between about 1 and about 15 seconds during which none of the four colorants are dispensed.

10. The method according to claim 9, wherein each dispensing step includes dispensing one or more of the colorants at a rate of between about 5 lb./hr and about 30 lb./hr.

11. The method according to claim 9, wherein different ones of the colorants are dispensed in different dispensing steps.

12. The method according to claim 9, wherein each of the one or more colorants is disposed in a corresponding carrier resin, and wherein the step of dispensing the one or more colorants comprises:
dispensing between about 0.4 and about 12 ounces of a first carrier resin carrying a first colorant;
dispensing between about 0.1 and about 6 ounces of a second carrier resin carrying a second colorant;
dispensing between about 0.3 and about 12 ounces of a third carrier resin carrying a third colorant; and
dispensing between about 0.5 and about 18 ounces of a fourth carrier resin carrying a fourth colorant.

13. The method according to claim 12, wherein the step of dispensing each of the four carrier resins comprises:
dispensing between about 1.5 ounces and about 2.5 ounces of the first carrier resin;
dispensing between about 0.5 ounces and about 0.7 ounces of the second carrier resin;
dispensing between about 1.5 ounces and about 2.0 of the third carrier resin; and
dispensing between about 2.0 ounces and about 3.0 ounces of the fourth carrier resin.

14. The method according to claim 13, wherein the sequence is executed over a duration of between about 170 and about 200 seconds.

15. The method according to claim 14, wherein the step of conveying and mixing the base polymer and additives comprises conveying the base polymer and additives at a feed rate of between about 1,000 lb./hr and about 2,000 lb./hr.

16. The method according to claim 10, wherein a total volume of colorant dispensed over the duration of the sequence comprises:
between about 25% and about 31% of a first colorant;
between about 8% and about 13% of a second colorant;
between about 23% and about 25% of a third colorant; and
between about 35% and about 40% of a fourth colorant.

17. The method according to claim 1, further comprising heating the composite material as it is conveyed though the extrusion barrel to form a molten composite.

18. The method according to claim 17, wherein the heating comprises electrical heating.

19. The method according to claim 1, wherein the twin-screw extruder comprises a plurality of screw segments arranged to form twelve discrete processing zones, and wherein the first mixing region comprises a first five of the twelve processing zones and the second mixing region comprises a last seven of the twelve processing zones.

20. The method according to claim 19, further comprising heating the composite material from a temperature of about 60° C. to a temperature of about 210° C. as it is conveyed along a first four of the twelve processing zones.

21. The method according to claim 20, further comprising cooling the composite material from a temperature of about 210° C. to a temperature of about 150° C. as it is conveyed along a last eight of the twelve processing zones.

22. Them method according to claim 1, wherein the one or more colorants are dispersed in a carrier polymer, and wherein the carrier polymer comprises a material that is different from the base polymer.

23. The method according to claim 1, wherein the carrier resin is selected from high density polyethylene, low density polyethylene, linear low density polyethylene, polypropylene, polycarbonate, thermoplastic polyurethane, an alloy of polycarbonate and thermoplastic polyurethane, polystyrene, acrylonitrile butadiene styrene (ABS), and acrylonitrile atyrene acrylate (ASA).

24. The method according to claim 1, wherein one or more of the colorants are dispersed in a carrier polymer, and wherein the carrier polymer comprises the same material as the base polymer.

25. The method according to claim 24, wherein the carrier polymer has a melt flow index that is substantially the same as a melt flow index of the base polymer.

26. The method according to claim 24, wherein the carrier polymer has a melting point that is substantially the same as a melting point of the base polymer.

27. The method according to claim 1, wherein the additives comprise one or more of an internal processing lubricant, a base colorant, and a flame retardant.

28. A system for forming an extruded fiber-plastic composite product, the system comprising:
(a) a twin-screw extruder comprising;
(i) a pair of extrusion screws disposed in parallel, each comprising a plurality of discrete screw segments connected in series and configured for mixing and conveyance of a base polymer;
(b) an extrusion barrel defining an inner cavity housing the twin-screw extruder and comprising:
(i) a first entry port for introduction of the base polymer;
(ii) a second entry port, downstream of the first entry port, for introduction of a plurality of fibers and one or more colorants; and
(c) an extrusion die disposed downstream of the second entry port, wherein the twin-screw extruder is configured to convey the materials through the extrusion die, thereby to form an extruded product,
wherein the plurality of discrete screw segments of a given one of the screws include segments having contrasting screw profiles arranged to define a first region configured for relatively high shearing of the base materials, thereby to provide a thoroughly mixed composite material; and
a second region, downstream of the first region, configured for relatively low shearing of the composite material and colorants, thereby to inhibit thorough mixing of the one or more colorants with the composite material.

29. The system according to claim 28, wherein the first region is configured for relatively high kneading of the base material.

30. The system according to claim 28, wherein the extrusion screws are configured for co-rotational movement.

31. The system according to claim 28, wherein the first region comprises a plurality of screw segments arranged to form a plurality of discrete processing zones including
a first processing zone including one or more conveying elements;
a second processing zone including one or more feed elements and disposed downstream of the first processing zone; and
a third processing zone including one or more kneading elements and disposed downstream of the second processing zone.

32. The system according to claim 31, wherein the first region further comprises a fourth processing zone disposed downstream of the third processing zone and including one or more conveying elements.

33. The system according to claim 32, wherein the first region further comprises a fifth processing zone disposed downstream of the fourth processing zone and including one or more kneading elements.

34. The system according to claim 28, wherein the second region comprises a plurality of screw segments arranged to form a plurality of discrete processing zones including
a sixth processing zone disposed downstream of the first region including one or more conveying elements; and
a seventh processing zone disposed downstream of the sixth processing zone and including one or more mixing elements.

35. The system according to claim 34, wherein the second region further comprises an eighth processing zone disposed downstream of the seventh processing zone and including one or more conveying elements.

36. The system according to claim 35, wherein the second region further comprises a ninth processing zone disposed downstream of the eighth processing zone and including one or more mixing elements.

37. The system according to claim 36, wherein the second region further comprises a tenth processing zone disposed downstream of the ninth processing zone and including one or more conveying elements.

38. The system according to claim 37, wherein the second region further comprises an eleventh processing zone disposed downstream of the tenth processing zone and including one or more mixing elements.

39. The system according to claim 38, wherein the second region further comprises a twelfth processing zone disposed downstream of the eleventh processing zone and including one or more conveying elements.

40. The system of claim 28, further comprising a side-feeder arranged in fluid communication with the second entry port and configured for controlled dispensing of the fibers or one or more colorants into the composite material.

41. The system of claim 40, further comprising a programmable logic controller configured to control the dispensing of the fibers or one or more colorants, wherein the programmable logic controller is configured to control at least one of an amount of colorant to be dispensed, a time period during which the colorant is dispensed, and a length of time between colorant dispensings.

42. The system of claim 40, wherein the side-feeder comprises a multiple-array feeder including a plurality of discrete feeders each containing a corresponding colorant and each operable to dispense the corresponding colorant.

43. The system of claim 28, wherein the extrusion barrel further comprises an additional entry port disposed in a position downstream of the second entry port for introducing one or more additional colorants or additives.

44. The system of claim 28, wherein the screw segments are arranged to form a screw profile that allows for controlled mixing of the one or more colorants with the base materials, thereby to provide a desired visual effect on the extrudate.

45. A composite extrudate, comprising:
(a) a base polymer;
(b) a plurality of fibers dispersed in the base polymer; and
(c) four or more colorants, of different hues, visible on a surface of the extrudate and forming a random pattern.

46. The composite extrudate according to claim 45, wherein the random pattern mimics the appearance of natural wood.

47. The composite extrudate according to claim 45, wherein the colorants are dispersed in a carrier polymer comprising the same material as the base polymer.

48. The composite extrudate according to claim 45, wherein the colorants are dispersed in a carrier polymer having a melt flow index that is substantially the same as a melt flow index of the base polymer.

49. The composite extrudate according to claim 45, wherein the colorants are dispersed in a carrier polymer having a melting point that is substantially the same as a melting point of the base polymer.

50. The composite extrudate according to claim 45, wherein the base polymer comprises a crystalline polymer.

51. The composite extrudate according to claim 50, wherein the colorants are dispersed in a carrier polymer comprising a crystalline polymer.

52. The composite extrudate according to claim 51, wherein the colorants are dispersed in a carrier polymer comprising an amorphous polymer.

53. The composite extrudate according to claim 45, wherein the extrudate has a substantially uniform density throughout a cross-section of the extrudate.

54. The composite extrudate according to claim 45, wherein the extrudate includes more than 50 percent by weight of the fibers.

55. The composite extrudate according to claim 45, wherein the colorants are dispersed in a carrier polymer selected from the group consisting of polyolefins, styrenes, urethanes, polycarbonates, and ABS resins.

56. The composite extrudate according to claim 45, wherein the fibers are selected from the group consisting of wood, hemp, kenaf, abaca, jute, flax, and ground rice hulls.

57. The composite extrudate according to claim 45, wherein the random pattern includes a sharp delineation in color.

58. The composite extrudate according to claim 45, wherein the random pattern includes a gradual shifting of color.

59. The composite extrudate according to claim 45, wherein the base polymer comprises a polyethylene mixture including virgin HDPE, recycled HDPE, and reprocessed composite material including HDPE and natural fibers.

60. The composite extrude according to claim 59, wherein the polyethylene mixture comprises between about 30 and about 40 percent by weight virgin HDPE, and between about 0 and about 15 percent by weight recycled HDPE, and between about 0 and about 10 percent by weight reprocessed composite material.

61. The composite extrudate according to claim 45, further comprising one or more additives selected from the group consisting of a base colorant, a lubricant, and a flame retardant.
